(19) United States
(12) Patent Application Publication
(10) Pub. No.: US 2018/0158458 A1
(43) Pub. Date: Jun. 7, 2018

(54) CONVERSATIONAL VOICE INTERFACE OF CONNECTED DEVICES, INCLUDING TOYS, CARS, AVIONICS, MOBILE, IOT AND HOME APPLIANCES

(71) Applicant: SHENETICS, INC., La Jolla, CA (US)

(72) Inventor: Dean Weber, La Jolla, CA (US)

(21) Appl. No.: 15/789,248

(22) Filed: Oct. 20, 2017

Related U.S. Application Data
(60) Provisional application No. 62/411,494, filed on Oct. 21, 2016.

(51) Int. Cl. G10L 15/22; G10L 15/30; G10L 15/18

(52) U.S. Cl. CPC G10L 15/22; G10L 2015/223; G10L 15/1815; G10L 15/30

(57) ABSTRACT

An apparatus and method for interacting between users and connected devices utilizing a conversational voice user interface. The device is connected over a network to a cloud-based Artificial Intelligence Dialogue System that controls conversational interactions and allows for real time updates to dialogue content.

### RELATED APPLICATIONS

This patent application claims priority to U.S. Provisional Patent Application Ser. No. 62/411,494 filed on Oct. 21, 2016, which is incorporated herein by reference, and entitled “Conversational Voice Interface of Connected Devices, Including Smart Toys and Smart Home Appliances.”

### BACKGROUND

### Field of the Disclosure

Aspects of the disclosure relate in general to an artificial intelligence dialogue system that controls conversational interactions with a device and allows for real time updates to dialogue content.

### Description of the Related Art

In the industrial design field of human-machine interaction, the user interface (UI) is the space where interactions between humans and machines occur. The interaction allows effective operation and control of the machine from the human end, while the machine simultaneously feeds back information that aids the operators' decision-making process. Examples of this broad concept of user interfaces include the interactive aspects of computer operating systems, and process controls. The design considerations applicable when creating user interfaces are related to or involve such disciplines as ergonomics and psychology.

With the increased use of personal computers and the relative decline in societal awareness of heavy machinery, the term user interface is generally assumed to mean the graphical user interface, while industrial control panel and machinery control design discussions more commonly refer to human-machine interfaces.

Other terms for user interface are man-machine interface (MMI) and when the machine in question is a computer human-computer interface.

### SUMMARY

Embodiments include an apparatus and method of interacting between users and connected devices utilizing a conversational voice user interface.

### BRIEF DESCRIPTION OF THE DRAWINGS

The figures below illustrate an apparatus and method of interacting between users and connected devices utilizing a conversational voice user interface.

FIG. 1 depicts an example toy embodiment.

FIG. 2 illustrates a network diagram of toys connected to a cloud-based dialogue system.

FIGS. 3A-C depict example conversations.

FIGS. 4A-4B are a flow chart of an AI dialogue system embodiment.

FIG. 5 is a flow chart of a dialogue choice embodiment.

FIG. 6 illustrates an embodiment dialogue choice node structure.

FIG. 7 is a flow chart of a dialogue action embodiment.

FIG. 8 illustrates an embodiment dialogue action node structure.

FIG. 9 is a flow chart of a dialogue concept embodiment.

FIG. 10 illustrates an embodiment dialogue concept node structure.

FIG. 11 is a flow chart of a graph search embodiment.

FIG. 12 is a flow chart of a semantic search embodiment.

FIG. 13 is a flow chart of a domain search embodiment.

FIG. 13 is a flow chart of a domain search embodiment.

FIG. 14 illustrates an asynchronous domain search embodiment.

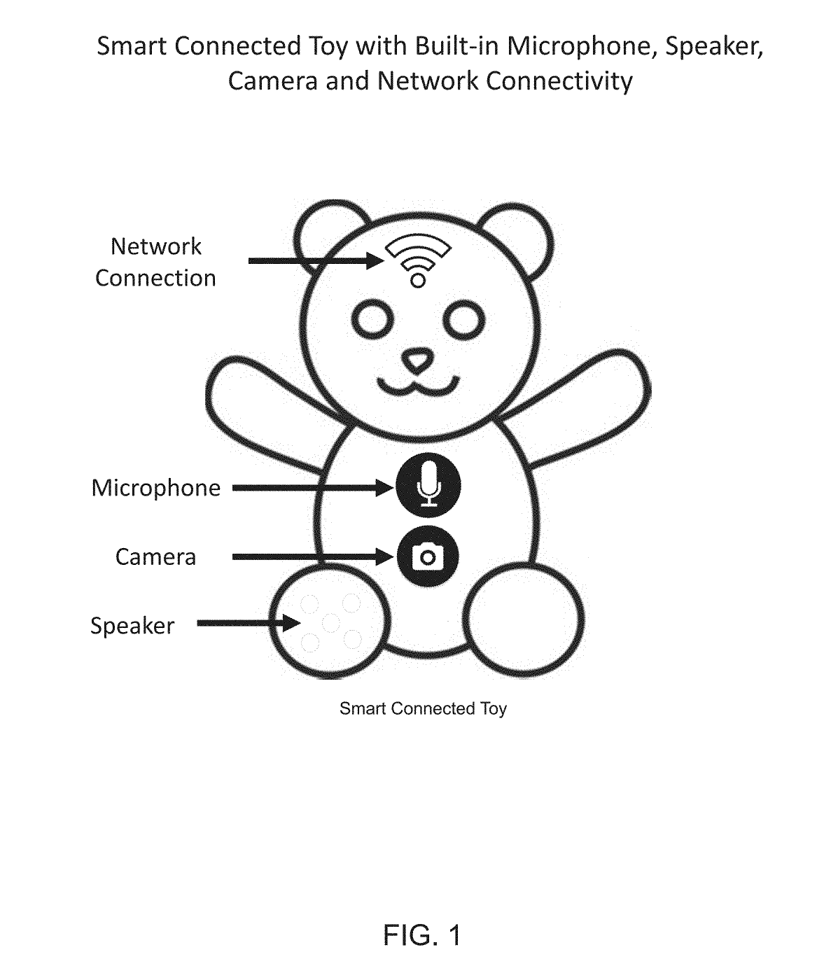

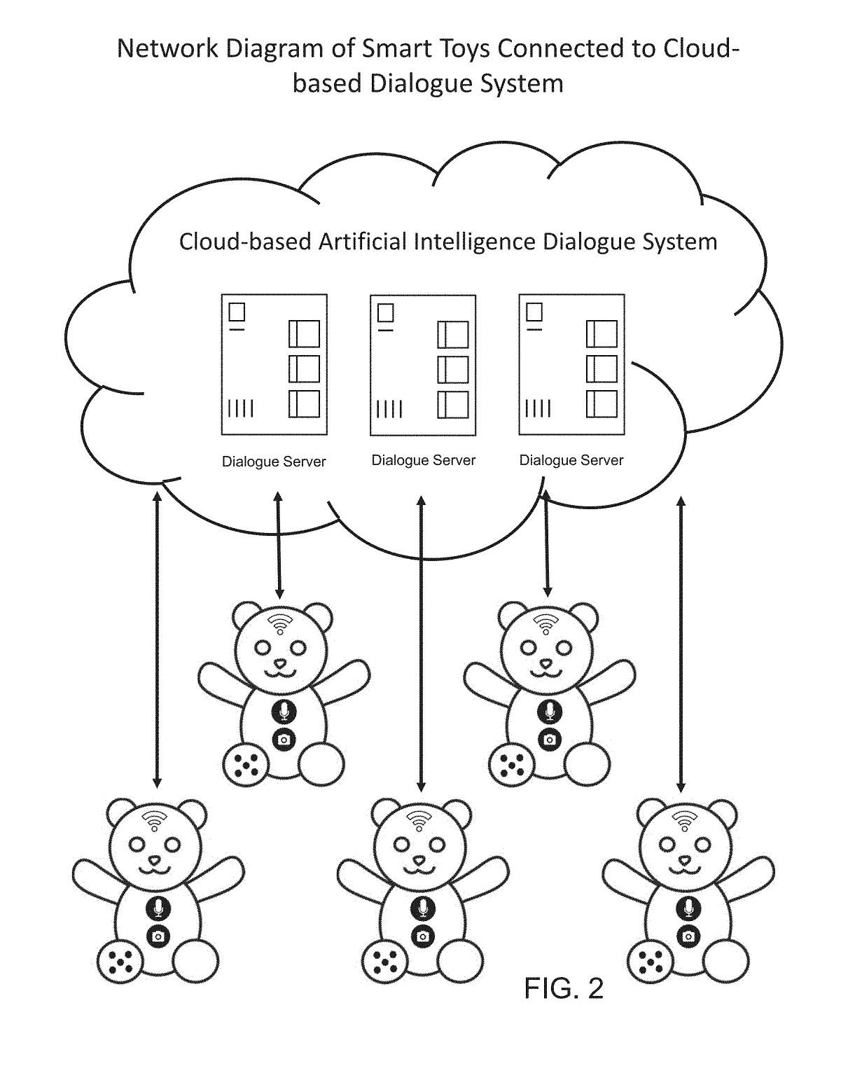

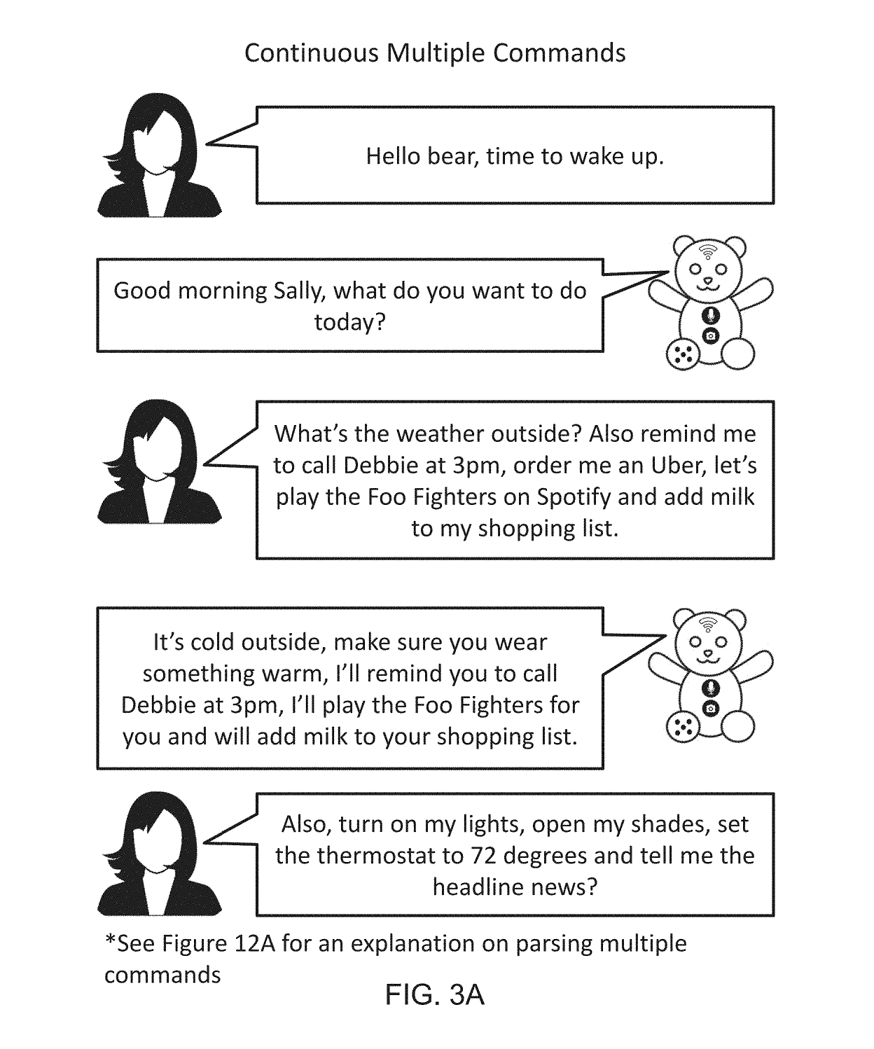

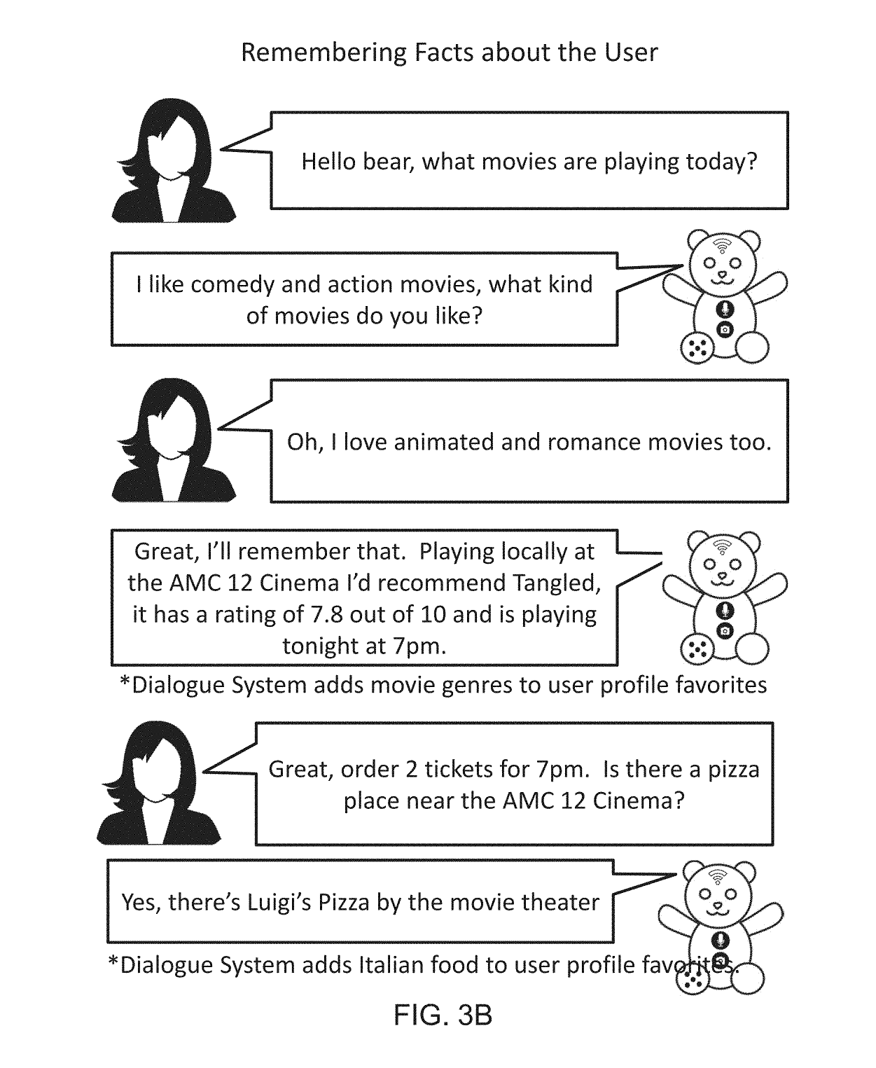

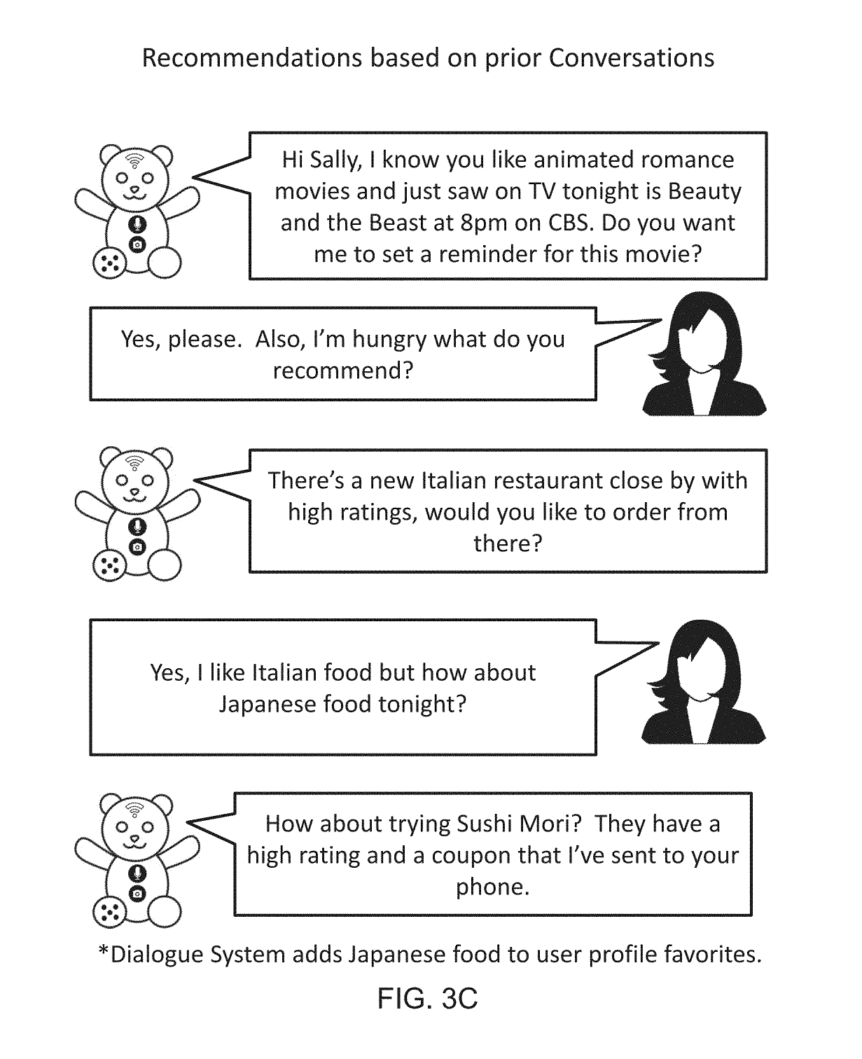

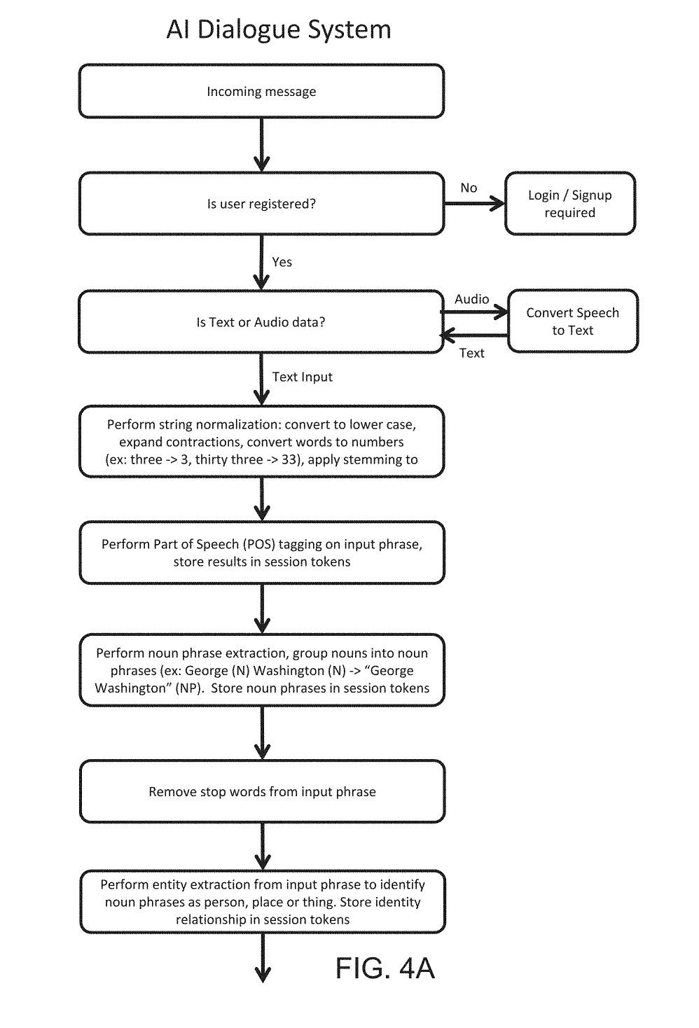

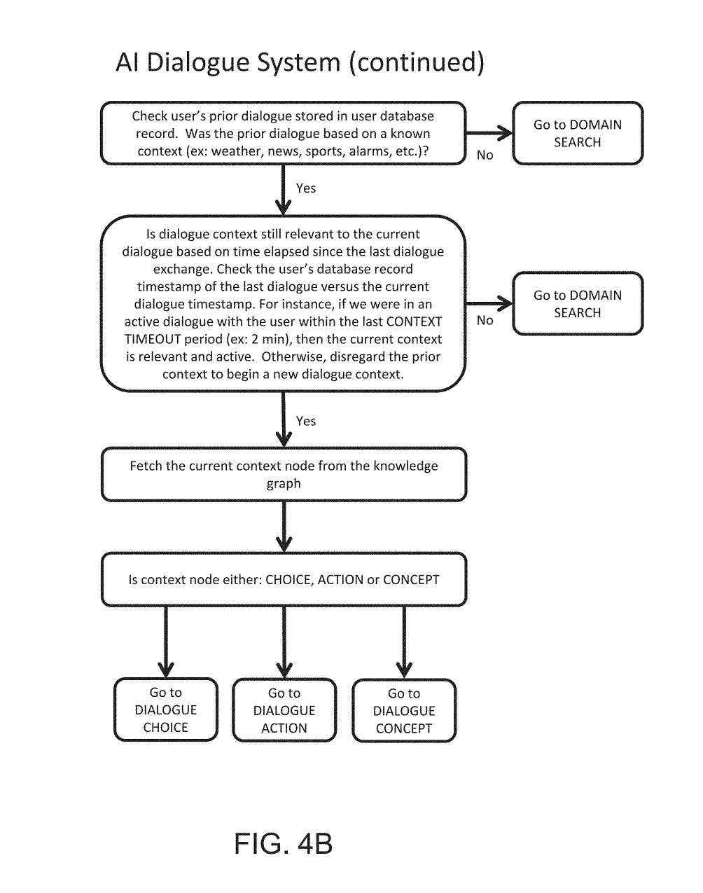

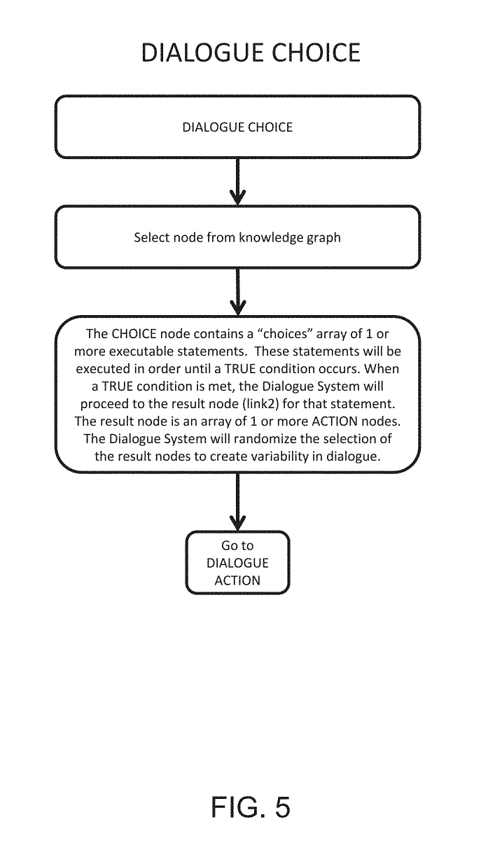

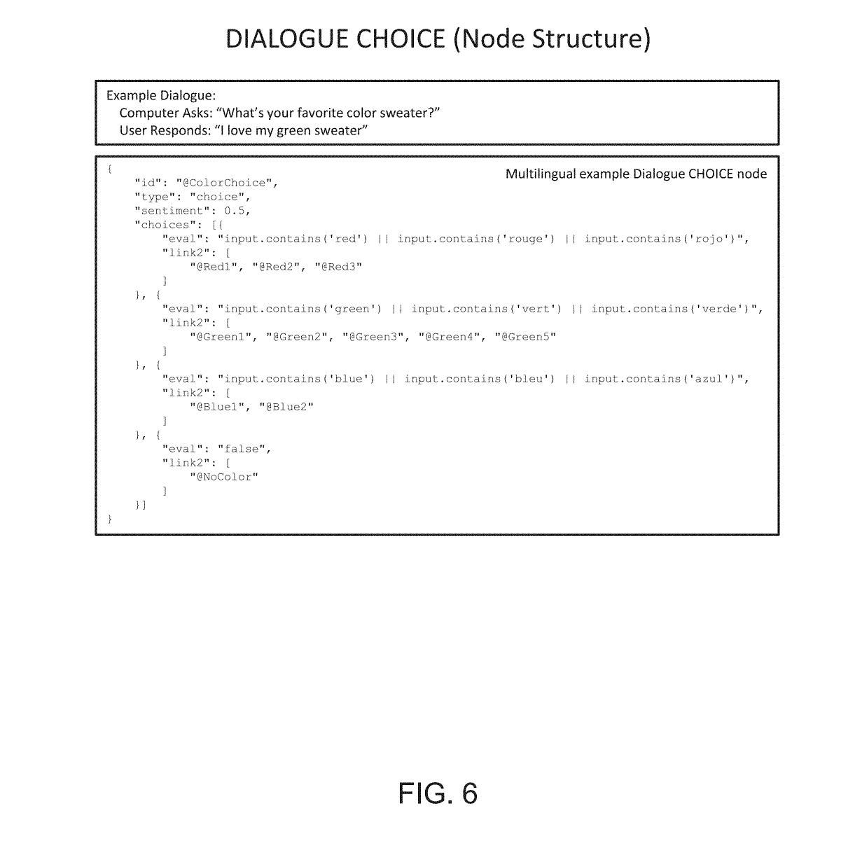

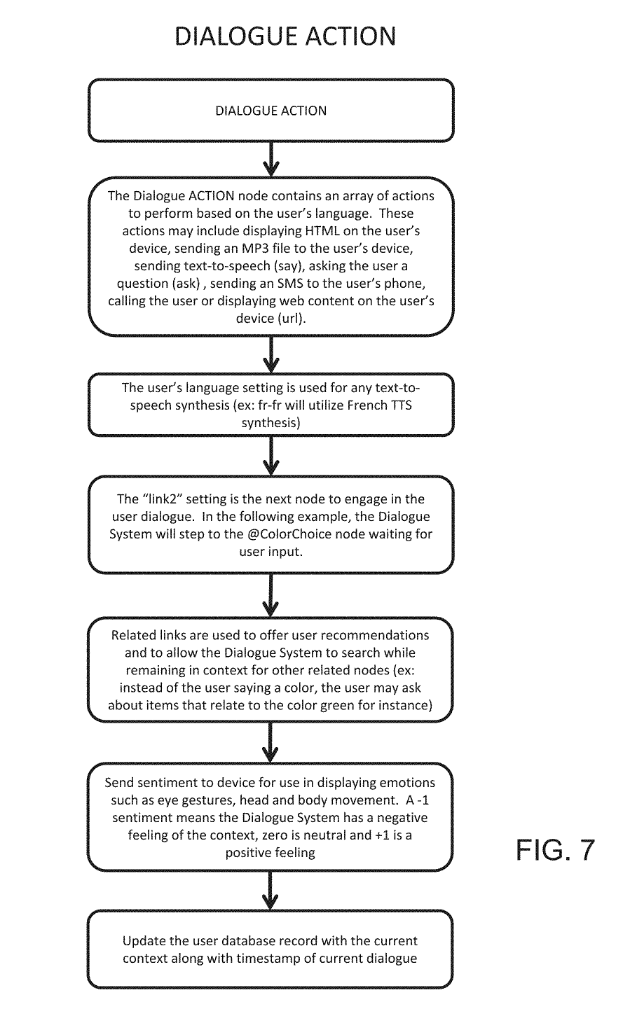

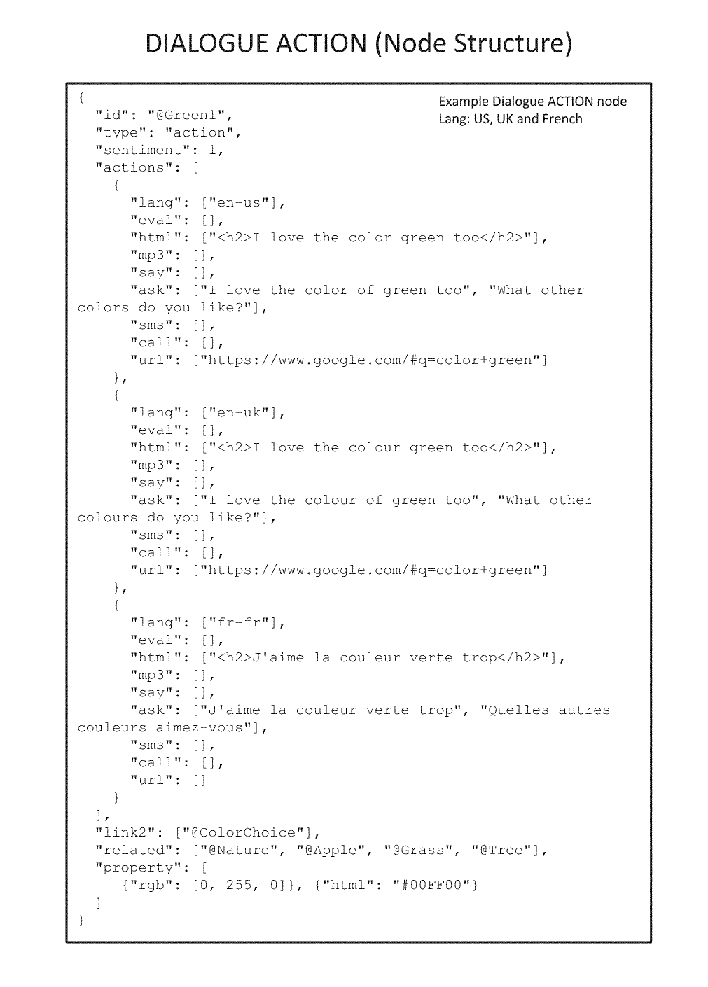

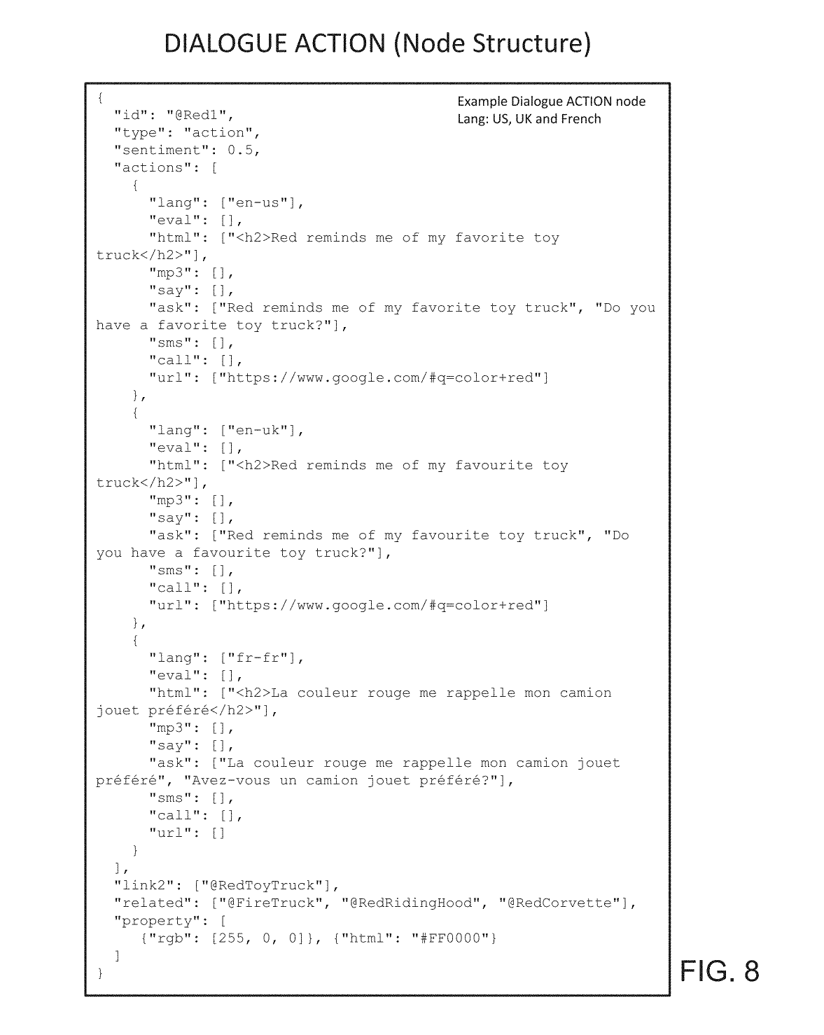

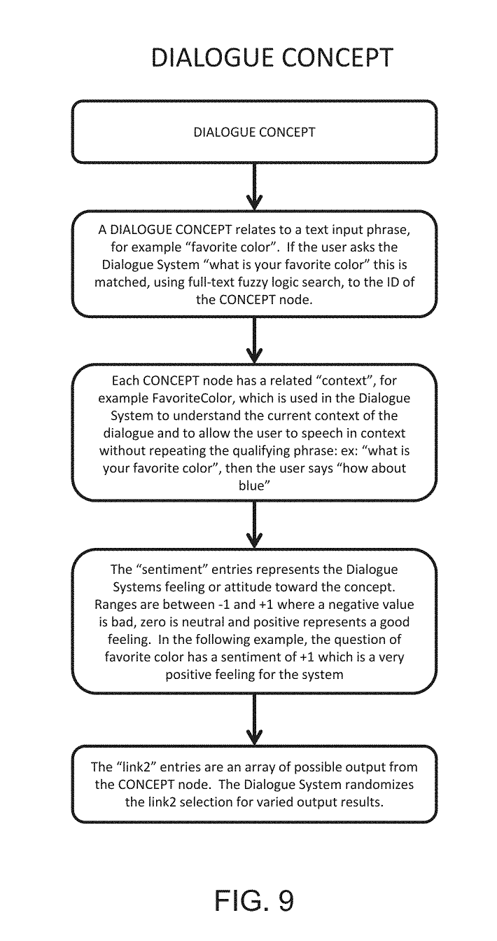

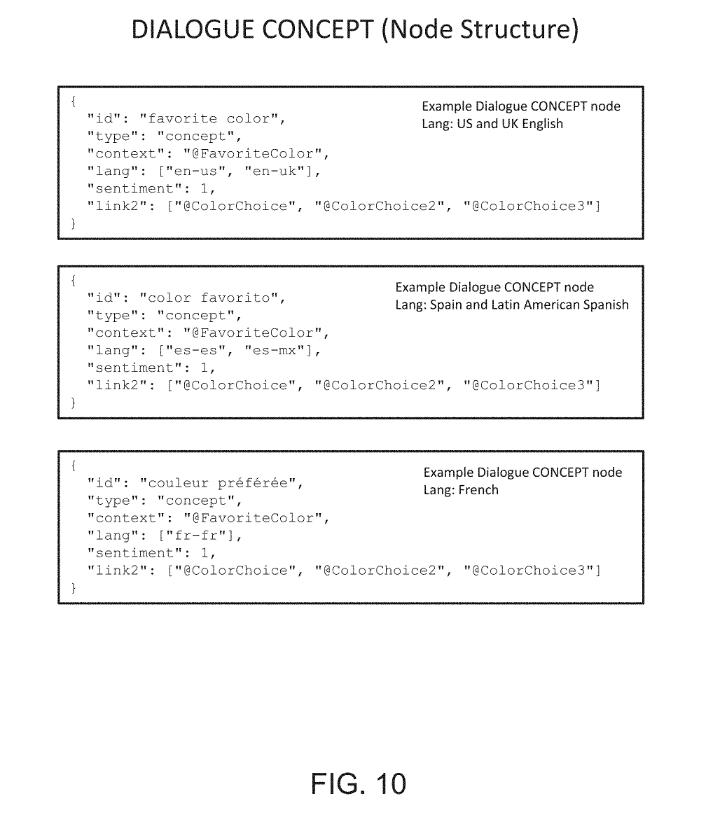

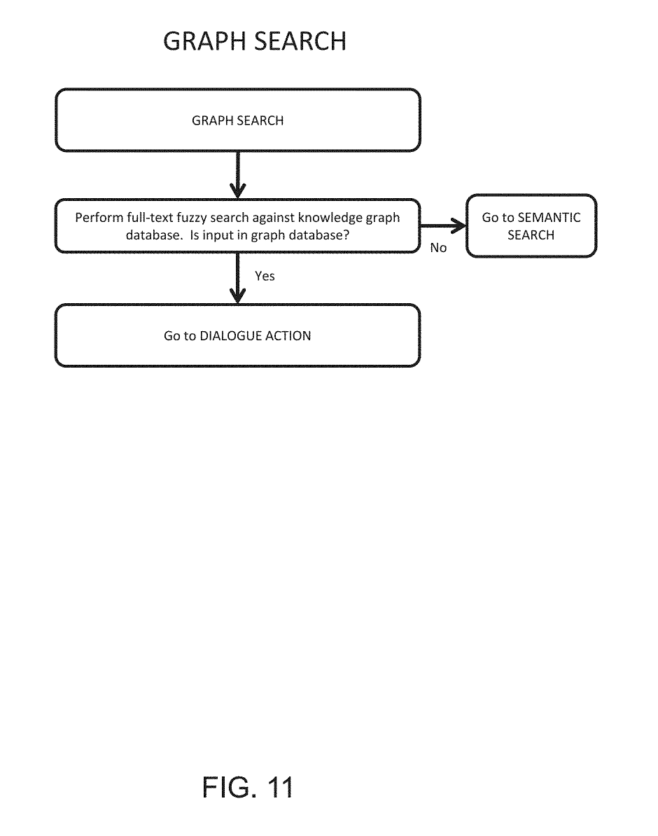

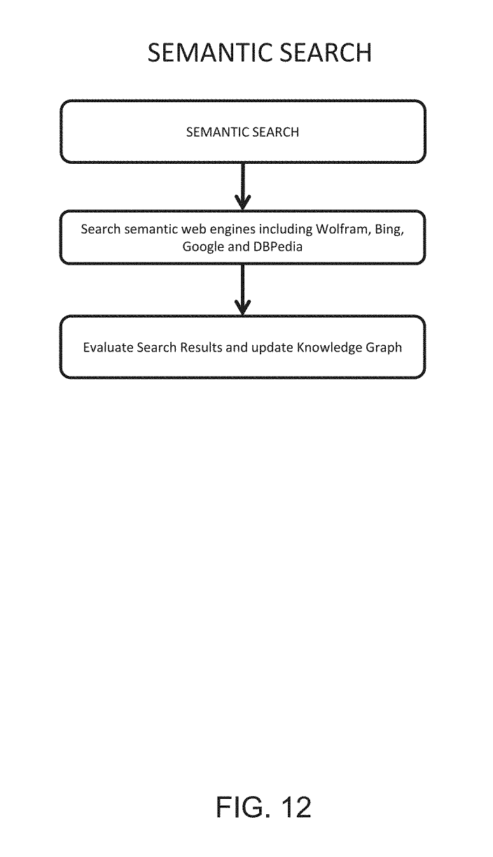

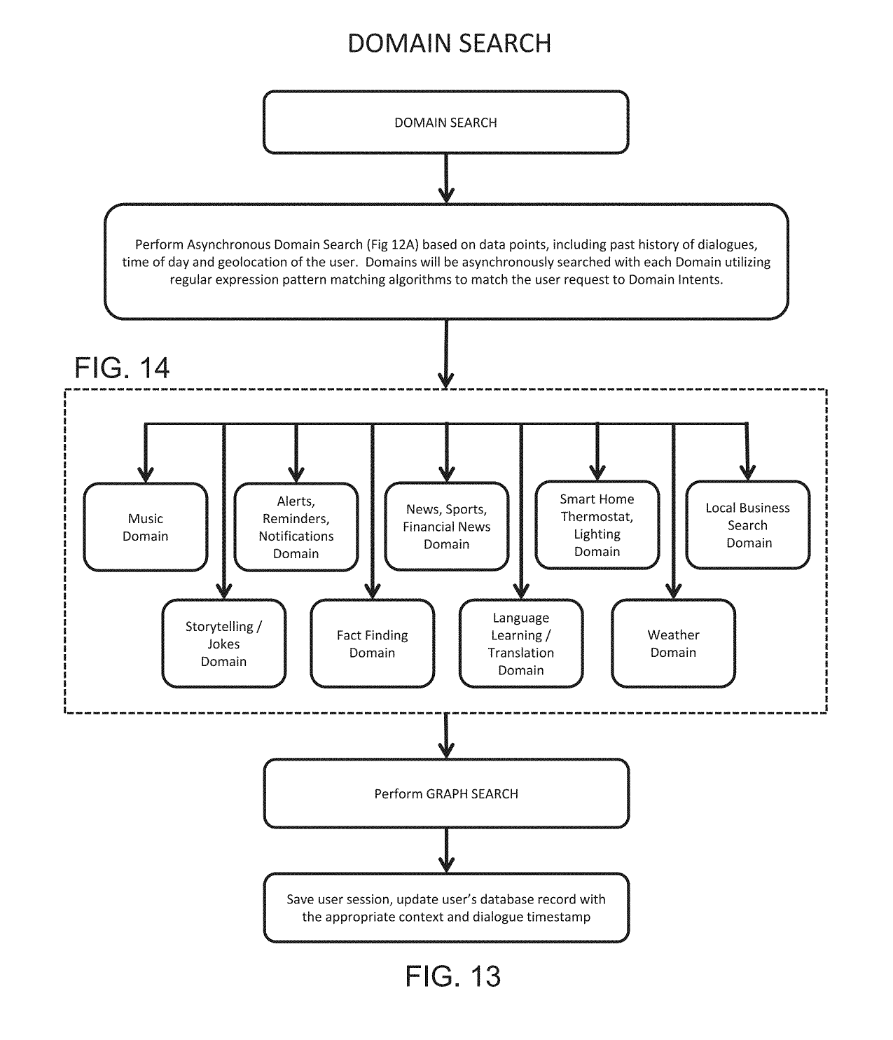

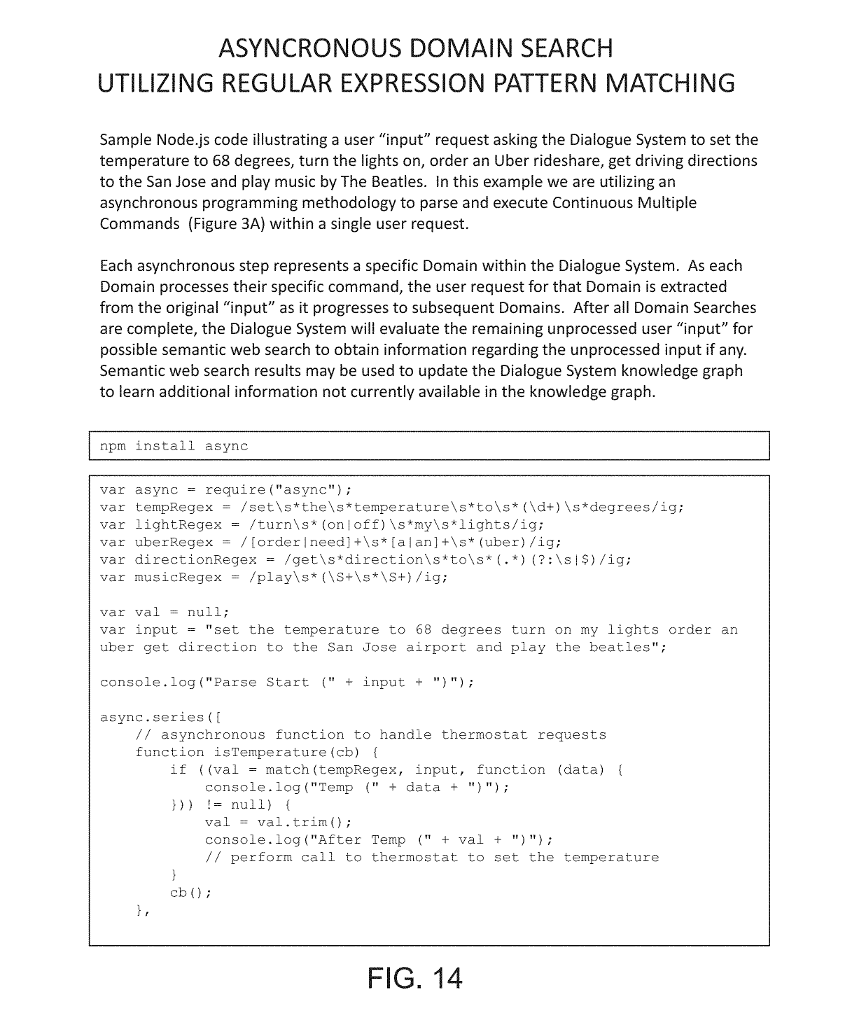

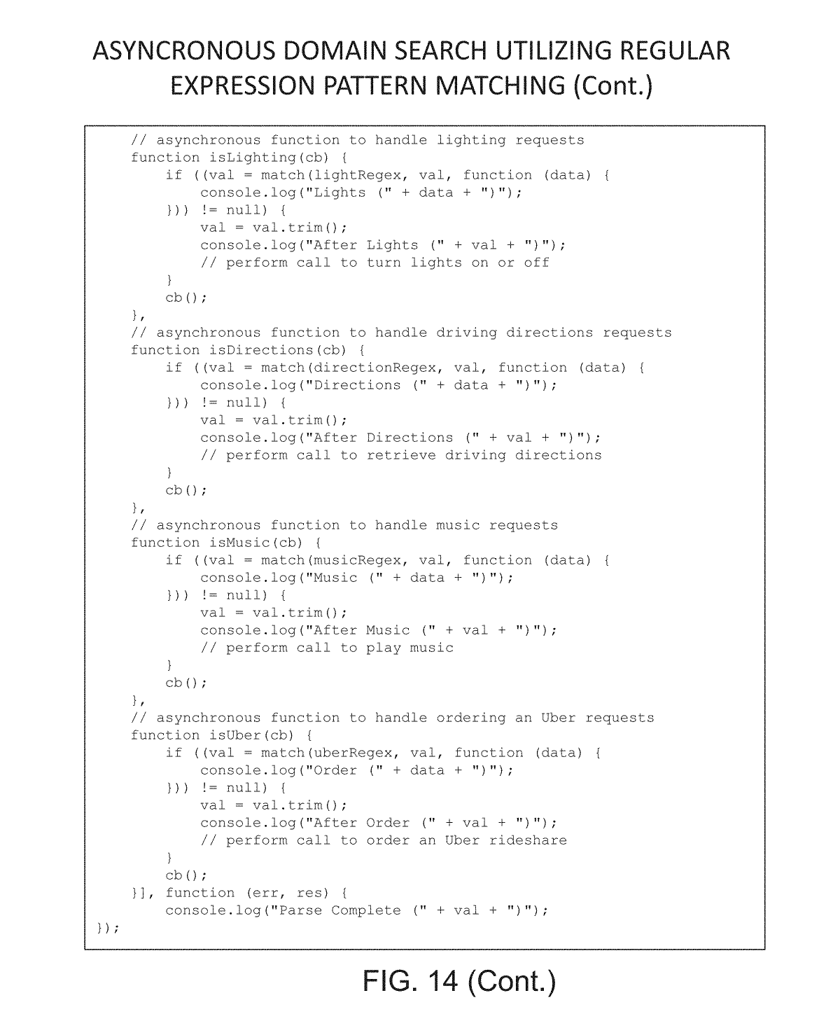

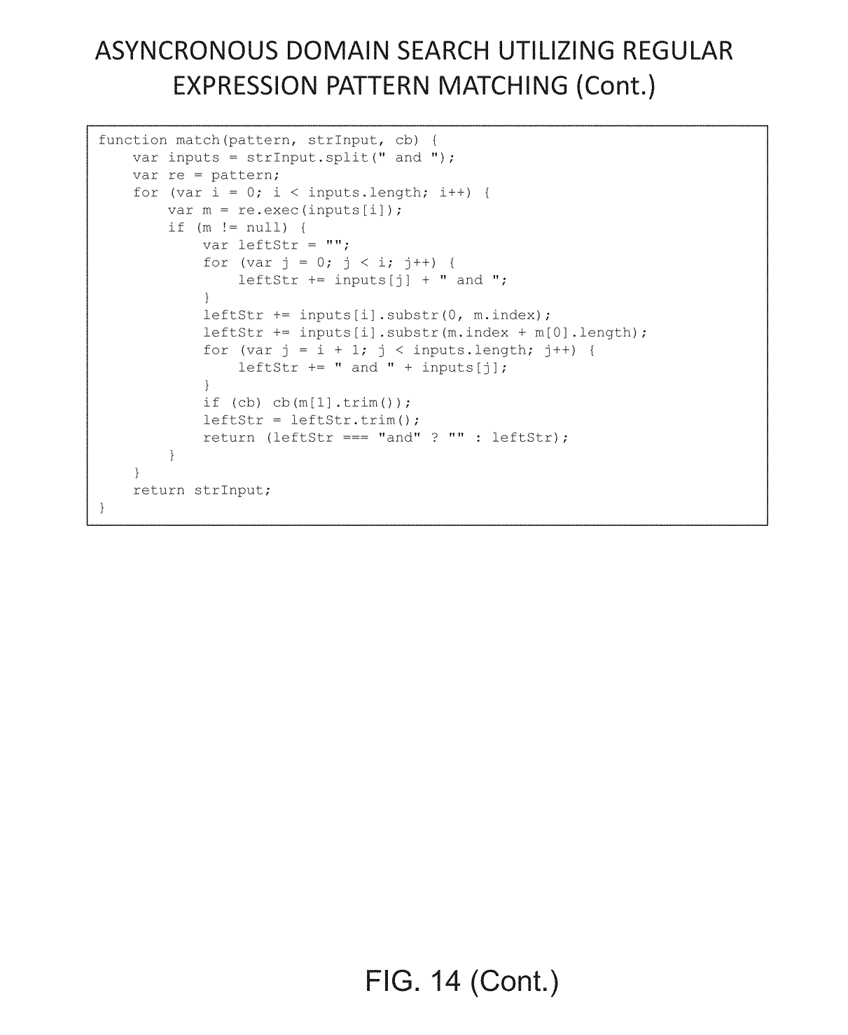

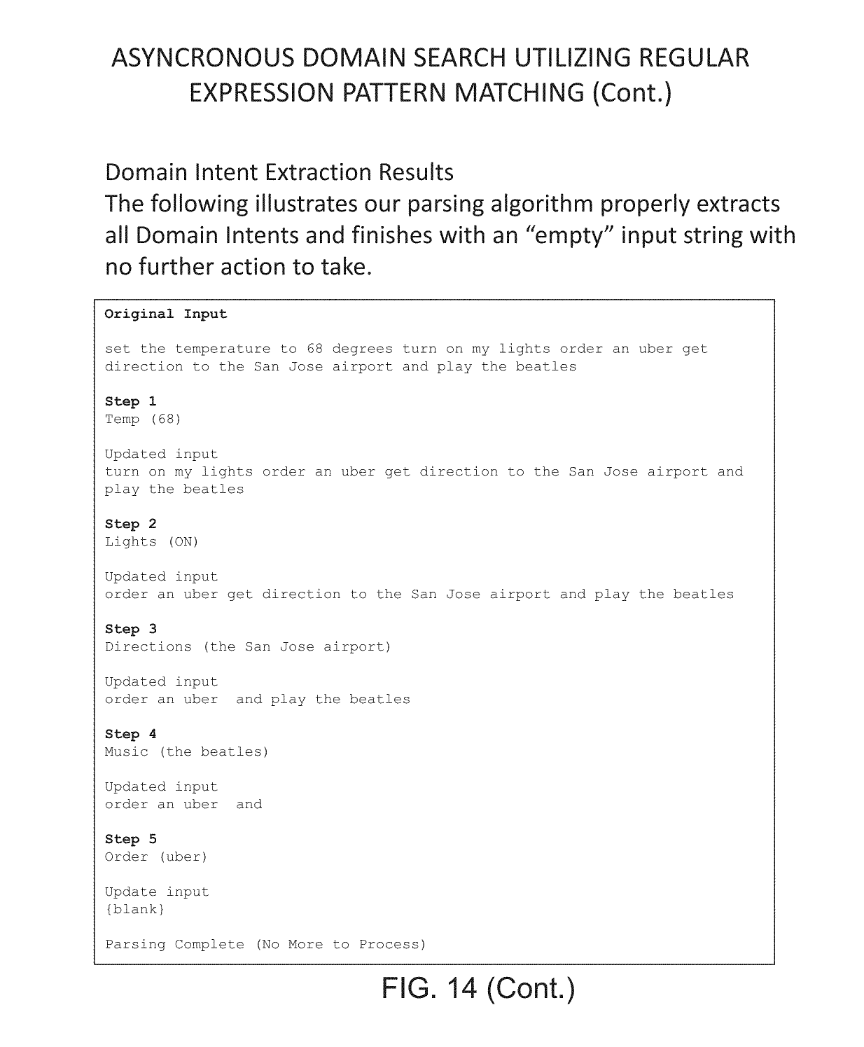

### DETAILED DESCRIPTION

Aspects of the present disclosure include an apparatus and method of interacting between users and connected devices utilizing a conversational voice user interface. The device, including smart connected toys, connected cars, airplanes, smart home appliances, mobile phones and connected home appliances (“Client Device” or “Client”), is connected over a network to an Artificial Intelligence (AI) Dialogue System that controls conversational interactions and allows for real time updates to dialogue content. By utilizing a conversational interface, the user and device interact naturally with voice inputs through speech recognition and audio output through either prerecorded sound files and/or text to speech synthesis or through text input from a computer, tablet or smartphone. The conversational aspect of the invention allows for a two-way dialogue between user and device creating a personal digital companion with artificial feelings, personalities, memories and emotions. The device can engage the user in storytelling, teaching, companionship, reminders, recommendations, control functionality and fact finding.

Embodiments include a network based client-server architecture where a Client Device is connected to a server that hosts an AI based Dialogue System. The end user interacts with the Client Device through a conversational voice interface. Clients may include toys, home appliances, mobile devices, automotive, avionics, wearables. In some embodiments, the server hosts an AI based Dialogue System. The end user interacts with the client device through a conversational voice interface.

The conversational voice interface is free-form, allowing natural language spoken input, including single and multiple commands in a single interaction. Either the user or the device may initiate a dialogue, meaning the user may take the lead in the conversation and ask the device a question or the device may take the lead and ask the user a question or notify the user of an event.

The client device is networking capable using such wireless technologies as Wi-Fi, Bluetooth or over a physical network connection. Once the client device is connected to the network (or Internet) it will connect to the AI Dialogue System. The client device has a unique registration ID which identifies that client device with a corresponding user account. A account information is used to store user settings, conversation logs and preferences which the Dialogue System may use for greetings, recommendations, notifications, and reminders. A user may have one or more devices linked to their account. Each client device will have a unique identifier used by the Dialogue System to interact directly with a specific client device. Unique identifiers may be randomly generated or use a standard GUID format.

The process of communication between the device to the Dialogue System is using standards based protocols such as TCP/IP web sockets, socket IO and/or HTTP/REST. The protocol is used to send data bi-directionally, including device ID, audio, XML, JSON and/or text string data.

In a user initiated dialogue scenario, the user engages a microphone on the device by either pressing a microphone button, speaking a voice wakeup command or performing a gesture. If the device supports voice wakeup, the user speaks a keyword phrase to wake up the device followed by a voice command. For example, the voice wakeup phrase could be “Hello bear” which when spoken would activate listening mode on that device. After the voice wakeup phrase is spoken the user would speak a command, for example “Time to wake up” or “Tell me a story”. In either scenario where the user presses a microphone button or after voice wakeup, the device will be in listening mode. In listening mode, audio is passed from the device to a speech recognition engine. The speech recognition engine can either be cloud-based or built-in to the device. The speech recognition engine will convert spoken audio into text using speech to text technology. The recognized text is then sent to the Dialogue System for processing.

The Dialogue System is based on an AI process utilizing a graph database and machine learning/predictive analytics for improved performance over time based on prior conversations with the user that may span back an infinite amount of time.

In some embodiments, the client device may be either cloud-based or the Dialogue System may be embedded in the local client device. In such an embodiment, when that cloud-connection is not possible or fail to maintain connection, the client device will run the Dialogue System locally on the client device allowing for a seamless conversational interaction with the user without the need for cloud-connectivity.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. An apparatus connected over a network to a cloud-based Artificial Intelligence (AI) Dialogue System that controls conversational interactions and allows for real time updates to dialogue content.

2. A method wherein an Artificial Intelligence (AI) Dialogue System allows a user to speak in either a single command or a plurality of commands in an utterance.
